(19) United States
(12) Patent Application Publication
(10) Pub. No.: US 2002/0071406 A1
(43) Pub. Date: Jun. 13, 2002

(54) METHOD OF CALIBRATING RECEIVE AND/OR TRANSMIT SYSTEMS DRIVING AN ARRAY OF ACTIVE ANTENNAS AND CORRESPONDING MOBILE STATION

(76) Inventors: JACQUES BURSZTEJN, NEUILLY SUR SEINE (FR); FREDERIC GOURGUE, PARIS (FR)

Correspondence Address: SUGHRUE MION ZINN MACPEAK & SEAS, 2100 PENNSYLVANIA AVENUE N W, WASHINGTON, DC, 200373202

(21) Appl. No.: 09/146,244

(22) Filed: Sep. 3, 1998

(30) Foreign Application Priority Data
Sep. 4, 1997 (FR) 97 11007

(51) Int. Cl. H04Q 7/00; H04J 1/16

(52) U.S. Cl. 370/334; 370/241

(57) ABSTRACT

A base station of a space division multiple access digital cellular mobile radio system includes an array of active antennas dynamically creating receive and/or transmit beams in the direction of mobile stations present in the current cell associated with the base station. The array of active antennas is driven by receive and/or transmit systems. At least one of the mobile stations present in the current cell is a calibration transponder-station used, in addition to its conventional function, as a calibration transponder for receiving and/or transmitting at least one test signal enabling calibration of the receive and/or transmit systems.

### BACKGROUND OF THE INVENTION

1. Field of the Invention

The field of the invention is that of space division multiple access (SDMA) digital cellular mobile radio systems.

2. Description of the Prior Art

Each base station of a mobile radio system of the above kind comprises an array of active antennas (also called an “active antenna panel”). This dynamically and electronically creates receive and/or transmit beams (or pencil beams) in the direction of mobile stations present in the cell associated with the base station. An active antenna array therefore increases the directional gain and replaces the single antenna (or the two antennas of a diversity system) previously used in a base station of a conventional mobile radio system.

Each antenna of the array of active antennas is driven by a receive system when it is used to receive and by a transmit system when it is used to transmit. Note that the same antenna of the array can be used to transmit and to receive simultaneously if it is driven simultaneously by a transmit system and a receive system.

To be more precise, the invention concerns a method of calibrating receive and/or transmit systems driving an array of active antennas of the above kind.

The necessity of such calibration is explained hereinafter for the transmit systems and then for the receive systems.

The use of an array of active transmit antennas presupposes the execution of two steps, namely: acquisition and tracking of the direction of the mobile stations to be tracked and creation of beams in the wanted direction or directions. The acquisition and tracking step is effected by processing the signals received at the array of active antennas. The beam creation step consists in calculating the required relative amplitudes and phases at the output of the transmit systems to drive each of the active antennas of the array in such a fashion as to create the required beams.

A preferred implementation of the transmit systems consists in applying phase-shifts and attenuation in the baseband, i.e. prior to radio frequency transposition, filtering and amplification operations. Unfortunately phase rotations and gain or attenuation which are not totally under control occur during these operations. Furthermore, the transfer functions of two transmit systems each driving a separate antenna need not be identical. The differences between two transmit systems can be due to different cable lengths, different amplifier gains (and gains varying with temperature), the amplitude/phase (AM-PM) response of the amplifiers, etc. The baseband phase and amplitude relations are therefore degraded at the output of the transmit systems (i.e. at the antennas of the array), which degrades the quality of beam formation.

The phase rotation induced in each transmit system must be estimated so that it can be compensated. It is this estimation that is known as “transmit system calibration”. In the conventional way calibration is effected relatively regularly (for example several times per hour, per day or per week). An open loop calibration process is not practicable and it is necessary to measure the field actually radiated.

The current solution is to have a number of transponders (remote calibration receivers) in the coverage area. Each transponder, dedicated to this calibration function and at a fixed location, determines the local received field level. This current solution has the major drawback of being costly because the presence of permanent test equipment entails installation, maintenance and operation logistics.

The problem is substantially the same in the case of the receive systems. When an array of active receive antennas is used the relative phase of the signals received by the array of active antennas is lost before it reaches the detectors downstream of the various receive systems. This is because the radio signal reaching one of the antennas of the array passes through the various components (filters, amplifiers, cables, connectors, etc) of the receive system of that antenna before reaching the corresponding detector. In other words, the phase of the signal is modified along the receive path (also known as the “data path”). The value of this phase rotation changes slowly (for example because of temperature variations) and is not the same from one receive system to another.

As already explained hereinabove, the accuracy of the estimated arrival angle of the signals and the quality of beam formation depend on the relative phases between antennas of the array. The phase rotation induced in each receive system must be estimated so that it can be compensated. This is known as “receive system calibration”.

The current solution to the problem of receive system calibration consists in using a remote calibration transmitter dedicated to this calibration function and at a fixed location in the field. This location must be at a relatively great distance from the array of active antennas (at least 100 meters for links at cellular system frequencies) so that a plane wave impinges on the array of active antennas. The azimuth of the remote calibration transmitter being known, it is possible to determine the phase difference between the receive systems and therefore to determine the calibration to be effected (i.e. the compensation to be applied) to correct the estimated arrival angle and beam formation.

This current solution works well, but the presence of a remote calibration transmitter dedicated to this purpose and at a fixed location in the field has a number of drawbacks, including: increased maintenance costs, the need to find and equip a site for the remote calibration transmitter and the need for dedicated transmission means to control the remote calibration transmitter.

One objective of the invention is to overcome these drawbacks of the prior art.

To be more precise, one objective of the present invention is to provide a method of calibrating receive and/or transmit systems driving an array of active antennas that is simple to use and low in cost.

### SUMMARY OF THE INVENTION

These objectives and others that will become apparent hereinafter are achieved in accordance with the invention by means of a method of calibrating receive and/or transmit systems driving an array of active antennas, the array of active antennas being included in a base station of a space division multiple access digital cellular mobile radio system and dynamically creating receive and/or transmit beams in the direction of mobile stations present in the current cell associated with the base station, wherein at least one of the mobile stations present in the current cell is a calibration transponder-station used, in addition to its conventional function, as a calibration transponder for receiving and/or transmitting at least one test signal enabling calibration of the receive and/or transmit systems.

The general principle of the invention therefore consists in using mobile stations (referred to as “calibration transponder-stations” in the remainder of the description) as transponders for calibrating the receive and/or transmit systems.

Accordingly, the present invention does not necessitate any equipment (remote calibration receiver or transmitter) dedicated to the calibration function and at a fixed location in the field. Consequently, its cost is greatly reduced compared to the prior art solutions previously mentioned.

Furthermore, the calibration operation is not bothersome to calibration transponder-station users because it is transparent from their point of view (for example it is effected while the station is in the standby mode).

Moreover, the method of the invention is simple to use because it merely necessitates the addition of a few functions in the mobile stations used as calibration transponders.

The process is preferably of the iterative type so that the accuracy of calibration of the receive and/or transmit systems is enhanced by successive iteration.

In the case of calibration of the receive systems, the method advantageously comprises the following steps:

the base station transmits to at least one calibration transponder-station a request to transmit at least one predetermined test signal;

on receiving the transmission request, each calibration transponder-station concerned transmits the at least one test signal;

the base station receives and analyzes the at least one test signal;

the base station determines the calibration to be effected on the receive systems according to the analysis of the at least one test signal.

In this case, each calibration transponder-station concerned constitutes a remote calibration transmitter. It is important to note that this remote calibration transmitter, unlike that of the prior art, is not dedicated to the calibration operation and does not occupy a fixed location in the field.

The request to transmit at least one test signal advantageously specifies at least one characteristic of the at least one test signal.

In this way the test performed is adapted to the receive control systems to be calibrated. Not all the base stations are identical. Also, the same base station may operate in more than one mode (for example “high gain” and “low gain” mode), each mode using separate receive systems.

The at least one characteristic of the at least one test signal advantageously belongs to the group comprising: the transmit frequency, the transmit power, the time (and possibly the date) at which transmission begins, the duration of transmission and the transmit waveform.

In one particular embodiment of receive calibration in accordance with the invention the method comprises the following steps:

the request to transmit at least one test signal is broadcast by the base station and is used to select a plurality of calibration transponder-stations in accordance with at least one predetermined selection criterion;

the array of active antennas is commanded to create a receive beam with a predetermined reference shape to receive test signals transmitted by the plurality of selected calibration transponder-stations;

using a statistical approach, the angular distribution of the test signals received from the plurality of selected calibration transponder-stations is used to estimate the real shape of the receive beam created by the array of active antennas;

the reference and estimated shapes of the receive beam created by the array of active antennas are compared;

the base station determines the calibration to be effected on the receive systems according to the result of the comparison.

This particular embodiment of receive calibration is therefore based on a statistical approach which assumes that the calibration transponder-stations are substantially uniformly distributed with a sufficient density.

In the case of transmit system calibration an advantageous first embodiment of the method comprises the following steps for a given calibration transponder-station:

the base station transmits to the calibration transponder-station a first request for measurement during a predetermined first period and a second request for measurement during a predetermined second period;

the base station transmits a predetermined first test signal during the predetermined first period and the array of active antennas is commanded to assure substantially homogenous transmission in the area in which the calibration transponder-station is assumed to be located;

the calibration transponder-station effects at least a first measurement of the first test signal received and sends the base station a first response containing the at least one first measurement;

the base station receives and then processes the first response to deduce from it the angle of arrival associated with the calibration transponder-station;

the base station transmits a predetermined second test signal during the predetermined second period and the array of active antennas is commanded to create a transmit beam that can depend on the angle of arrival deduced by processing the first response received;

the calibration transponder-station effects at least one second measurement of the second test signal received during the predetermined second period and sends the base station a second response containing said at least one second measurement;

the base station receives and then processes the second response;

the base station compares the at least one first and second measurements and determines the calibration to be effected on the transmit systems according to the result of the comparison.

In this case, each calibration transponder-station constitutes a remote calibration receiver. Again, it is important to note that this remote calibration receiver, unlike that of the prior art, is not dedicated to calibration and does not occupy a fixed location in the field.

In this first embodiment the calibration of the transmit systems is therefore determined on the basis of comparing two measurements effected with different transmit beam shapes.

During the step of transmission by the base station of the second test signal, the intention is that the transmit beam created by the array of active antennas should advantageously have a power maximum substantially according to the angle of arrival deduced from processing the first response received, i.e. in the assumed direction of the calibration transponder-station.

The gain generated by the formation of the beam is therefore deduced from the measurement ratio (between the first and second measurements).

In an advantageous variant, during the step of transmission by the base station of the second test signal, the intention is that the transmit beam created by the array of active antennas should have a propagation zero substantially according to the angle of arrival deduced from the processing of the first response received, i.e. the assumed direction of the calibration transponder-station.

The efficacy of the propagation zero generated by the formation of the beam is therefore deduced from the measurement ratio (between the first and second measurements).

In the case of transmit system calibration, an advantageous second embodiment of the method comprises the following steps:

the base station broadcasts a request for measurement to be effected during a predetermined period, the measurement request also selecting a plurality of calibration transponder-stations in accordance with at least one predetermined selection criterion;

the base station transmits a predetermined test signal during the predetermined period, the array of active antennas being commanded to create a transmit beam with a predetermined reference shape;

each of the selected calibration transponder-stations effects at least one measurement of the received test signal and sends the base station a response containing the at least one measurement;

using a statistical approach, the angular distribution of the responses received from the plurality of selected calibration transponder-stations is used to estimate the real shape of the transmission beam created by the array of active antennas;

the reference and estimated shapes of the transmit beam created by the array of active antennas are compared;

the base station determines the calibration to be effected on the transmit systems in accordance with the result of the comparison.

This advantageous second embodiment of transmit calibration therefore does not rely on two successive measurements by the same calibration transponder-station but instead relies on a plurality of simultaneous measurements by a plurality of calibration transponder-stations. In other words, this is a statistical approach which assumes that the calibration transponder-stations are substantially uniformly distributed with sufficient density.

For (transmit or receive) embodiments based on a statistical approach, the at least one selection criterion advantageously belongs to the group comprising:

information related to the identification number of the mobile station; and

information related to the power level measured by the mobile station.

For the embodiments based on a statistical approach, the plurality of selected calibration transponder-stations preferably uses a collision management technique during the step of transmission of test signals or during the step of transmission of responses containing the measurements.

The invention also concerns a mobile station of a space division multiple access digital cellular mobile radio system adapted to communicate with a base station associated with a cell in which the mobile station is located, the base station comprising an array of active antennas driven by receive and/or transmit systems for dynamically creating receive and/or transmit beams in the direction of the mobile station, wherein the mobile station comprises means for receiving and/or transmitting at least one test signal for calibrating the receive and/or transmit systems so that it can be used, in addition to its conventional function, as a calibration transponder.

Other features and advantages of the invention will become apparent from a reading of the following description of one preferred embodiment of the invention given by way of illustrative and non-limiting example and from the accompanying drawings.

### BRIEF DESCRIPTION OF THE DRAWINGS

FIG. 1 is a simplified flowchart of a first particular embodiment of the method of the invention in the case of receive system calibration.

FIG. 2 is a simplified flowchart of a second particular embodiment of the method of the invention in the case of receive system calibration.

FIG. 3 is a simplified flowchart of a first particular embodiment of the method of the invention in the case of transmit system calibration.

FIG. 4 is a simplified flowchart of a second particular embodiment of the method of the invention in the case of transmit system calibration.

### DETAILED DESCRIPTION OF THE PREFERRED EMBODIMENTS

Thus the invention concerns a method of calibrating receive systems and transmit systems driving an array of active antennas of a base station of an SDMA digital cellular mobile radio system.

In accordance with the invention, one or more mobile stations present in the current cell are used, in addition to their conventional function, as calibration transponders. To this end, these mobile stations, or “calibration transponder-stations”, comprise means for receiving and/or transmitting test signals for calibrating the receive and/or transmit systems.

Clearly a calibration transponder-station can be used either for only one of the two types of calibration (i.e. either the receive systems or the transmit systems) or for both.

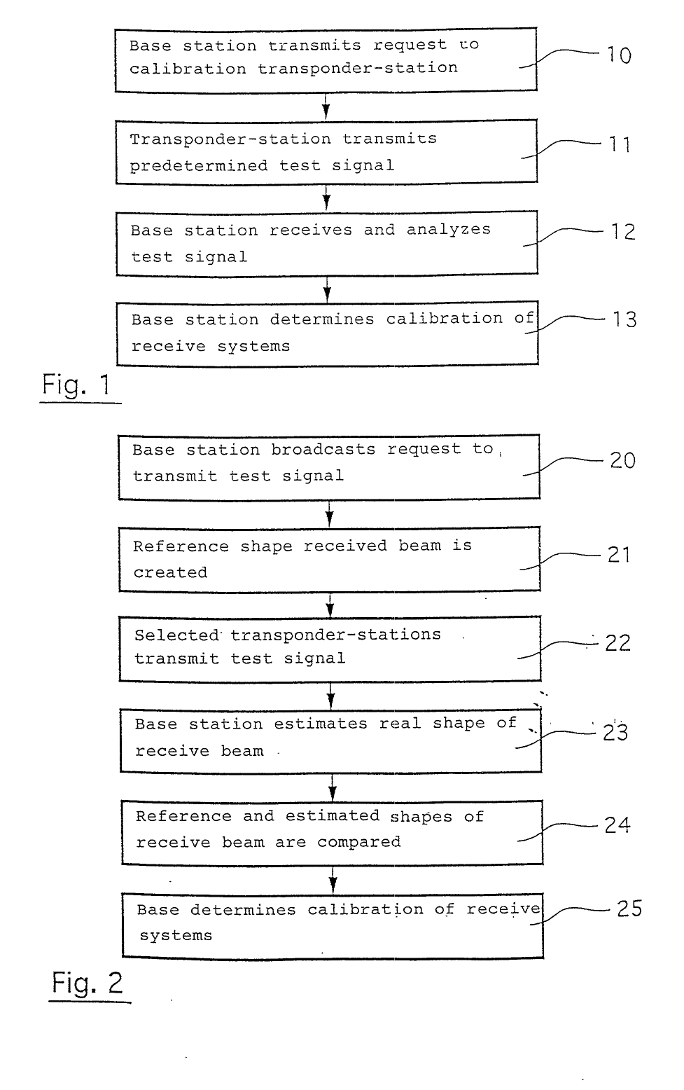

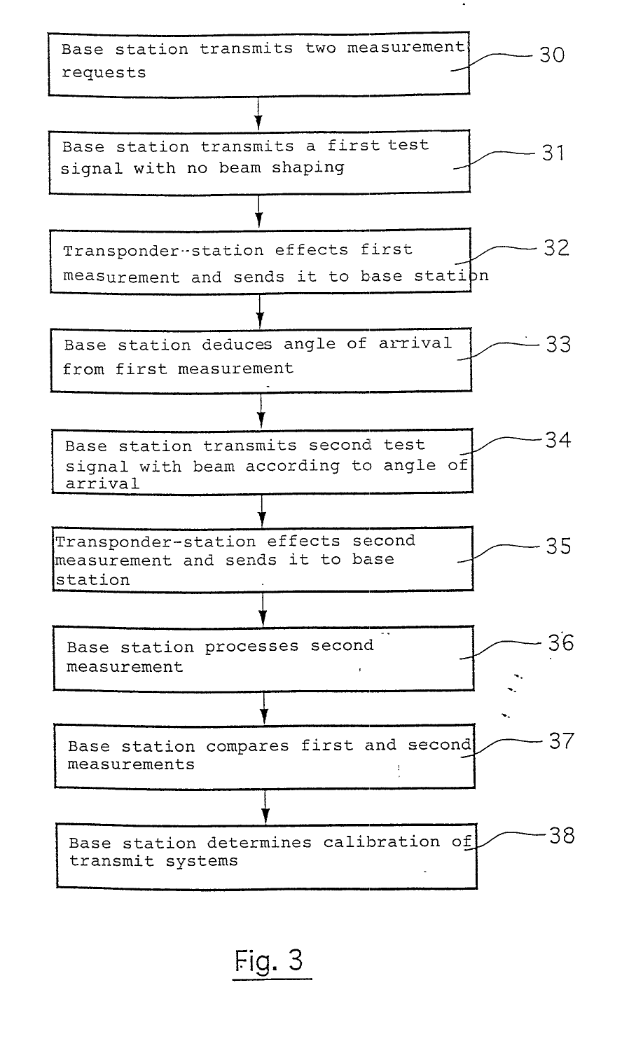

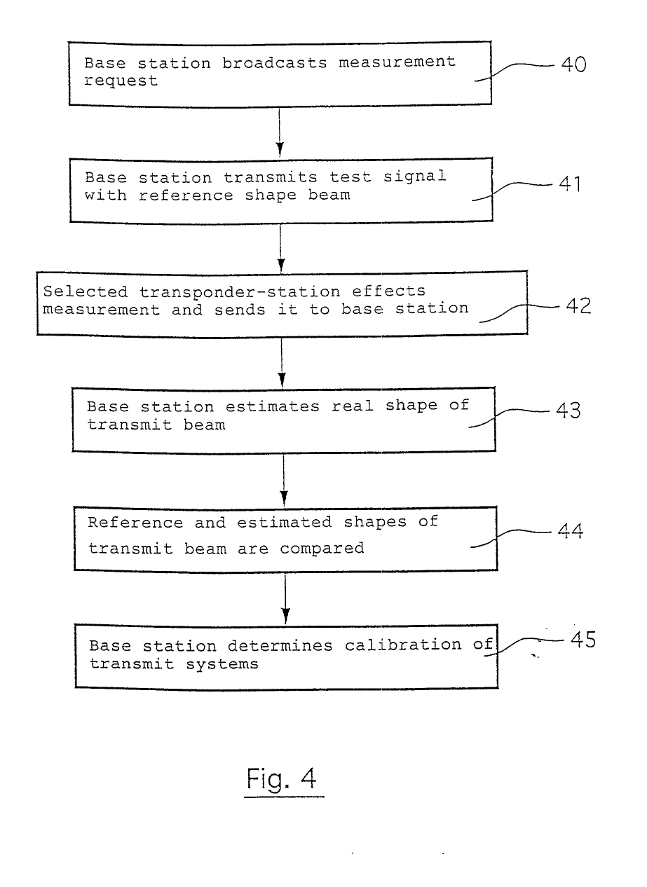

The remainder of the description begins with first and then second particular embodiments of the method of the invention, in relation to the FIG. 1 and 2 flowcharts, in the case of calibration of the receive systems. First and then second particular embodiments of the method of the invention in the case of calibration of the transmit systems are then described with reference to the FIG. 3 and 4 flowcharts.

The first embodiment of the method of the invention for calibrating the receive systems comprises the following steps (see FIG. 1):

the base station transmits a calibration transponder-station a request to transmit a predetermined test signal (step 10);

on receiving said transmission request, the calibration transponder-station transmits the predetermined test signal, as requested (step 11);

the base station receives and analyzes the test signal (step 12);

the base station determines the calibration to be effected on said receive systems according to the analysis of the test signal (step 13).

Steps 10 through 12 of this method can be reiterated with a plurality of calibration transponder-stations to improve the quality of calibration.

The request transmitted by the base station to the calibration transponder-station can specify certain characteristics of the test signal that the calibration transponder-station must transmit in response. Without the following list being exhaustive, these can be some or all of the following features: the transmit frequency, the transmit power, the time (and possibly the date) at which transmission begins, the duration of transmission, the transmit waveform, etc.

In this first embodiment, as in the second embodiment described hereinafter, the request transmitted by the base station to each calibration transponder-station can refer to the transmission of a plurality of predetermined test signals. In this case the analysis performed in step 12 concerns a plurality of received test signals.

The second embodiment of the method in accordance with the invention for calibrating the receive systems comprises the following steps (see FIG. 2):

the base station broadcasts a test signal transmission request (step 20). Although it is received by all the mobile stations present in the cell, this request may concern only some of them. For example, the request can select calibration transponder-stations according to the identification number (e.g. even or odd) or the power level measured by each mobile station (e.g. in the range −80 dBm to −70 dBm);

the array of active antennas is commanded to create a receive beam of predetermined shape known as the reference (or ideal) shape in order to receive the test signals transmitted by the plurality of selected calibration transponder-stations (step 21);

on receiving the transmit request, each calibration transponder-station selected transmits the predetermined test signal as requested (step 22). During this transmission step a collision management technique (e.g. Aloha) can be used;

the base station receives and analyzes the test signals transmitted by the selected calibration transponder-stations (step 23). The angular distribution of the received test signals enables the real shape of the receive beam created by the array of active antennas to be estimated by a statistical process. For example, a histogram is constructed representing the number of test signals received for different reception angles;

the base station (or any other component of the system) compares the reference and estimated shapes of the receive beam created by the array of active antennas (step 24);

depending on the result of this comparison, the base station determines the calibration to be effected on the receive systems with the objective of making the actual shape and the reference shape the same (step 25).

Steps 20 through 25 of this calibration method can be reiterated to improve the quality of receive calibration. The fact that the method of the invention can be an iterative method is equally true for the receive calibration method in the first embodiment described hereinabove (see FIG. 1) and for the transmit calibration methods described hereinafter (see FIGS. 3 and 4).

The first embodiment of the transmit system calibration method of the invention comprises the following steps (see FIG. 3):

the base station transmits two measurement requests to a calibration transponder-station (step 30). The first request is for the calibration transponder-station to effect a first measurement during a predetermined first period. The second request is for the calibration transponder-station to effect a second measurement during a predetermined second period. Clearly the first and second requests can be transmitted simultaneously or successively;

the base station transmits a predetermined first test signal during the predetermined first period (step 31). During this transmission the array of active antennas is commanded to assure substantially homogeneous transmission in the area in which the calibration transponder-station is assumed to be located. In other words, there is no beam formation;

in accordance with the first request previously received, the calibration transponder-station effects a first measurement of the first test signal received and sends the base station a first response containing this first measurement (step 32);

the base station receives and then processes the first response to deduce from it the angle of arrival associated with the calibration transponder-station (step 33);

the base station transmits a predetermined second test signal during the predetermined second period (step 34). During this transmission the array of active antennas is commanded to create a transmit beam dependent on the angle of arrival deduced by processing the first response received;

in accordance with the second request previously received, the calibration transponder-station effects a second measurement of the second test signal received during the predetermined second period and sends the base station a second response containing this second measurement (step 35);

the base station receives and then processes the second response (step 36);

the base station compares the first and second measurements (step 37) and according to the result of the comparison determines the calibration to be effected on the transmit systems (step 38).

During the step of transmission by the base station of the second test signal the intention is for the transmit beam created by the array of active antennas to have a power maximum (or a propagation zero) substantially in accordance with the angle of arrival deduced from processing the first response received, i.e. in the assumed direction of the calibration transponder-station.

The calibration transponder-station can also effect a plurality of first and/or second measurements. In this case the processing effected in step 33 can apply to one or more first responses containing the various first measurements. Similarly, the processing effected in step 36 can then apply to one or more second responses containing the various second measurements.

The second embodiment of the method of the invention for calibration of the transmit systems comprises the following steps (see FIG. 4):

the base station broadcasts a request for a measurement to be effected during a predetermined period (step 40). Although it is received by all the mobile stations present in the cell, this request may concern only some of them. For example, the request can select calibration transponder-stations according to the identification number (e.g. even or odd) or the power level measured by each mobile station (e.g. in the range −80 dBm to −70 dBm);

the base station transmits a predetermined test signal during the predetermined period (step 41). During this transmission, the array of active antennas is commanded to create a transmit beam of predetermined reference shape;

each of the selected calibration transponder-station measures the received test signal and sends the base station a response containing the measurement (step 42). During this step of sending of responses by the selector calibration transponder-stations, a collision management technique (e.g. Aloha) can be used, the base station indicating to the transponder-mobiles that a collision has occurred by means of a particular response message (or by the absence of a particular response message);

the base station receives and analyzes the responses received from the various selected calibration transponder-stations (step 43). The angular distribution of these responses enables the real shape of the transmit beam created by the array of active antennas to be estimated using a statistical method (already discussed in the case of receive calibration);

the base station (or any other component of the system) compares the reference and estimated shapes of the transmit beam created by the array of active antennas (step 44);

the base station determines the calibration to be effected on the transmit systems according to the result of the comparison (step 45).

There is claimed:

1. A method of calibrating receive and/or transmit systems driving an array of active antennas, said array of active antennas being included in a base station of a space division multiple access digital cellular mobile radio system and dynamically creating receive and/or transmit beams in the direction of mobile stations present in a current cell associated with said base station, wherein at least one of the mobile stations present in the current cell is a calibration transponder-station used, in addition to its conventional function, as a calibration transponder for receiving and/or transmitting at least one test signal enabling calibration of said receive and/or transmit systems.

2. The method claimed in claim 1 using successive iterations to improve the accuracy of calibration of said receive and/or transmit systems.

3. The method claimed in claim 1 wherein, in the case of calibration of said receive systems, said method comprises the following steps:
said base station transmits to at least one calibration transponder-station a request to transmit at least one predetermined test signal;
on receiving said transmission request, each calibration transponder-station concerned transmits said at least one test signal;
said base station receives and analyzes said at least one test signal;
said base station determines the calibration to be effected on said receive systems according to said analysis of said at least one test signal.

4. The method claimed in claim 3 wherein said request to transmit at least one test signal specifies at least one characteristic of said at least one test signal.

5. The method claimed in claim 4 wherein said at least one characteristic of said at least one test signal belongs to the group comprising:
the transmit frequency;
the transmit power;
the time, and possibly the date, at which transmission begins;
the duration of transmission;
the transmit waveform.

6. The method claimed in claim 3 including the following steps:
said request to transmit at least one test signal is broadcast by said base station and is used to select a plurality of calibration transponder-stations in accordance with at least one predetermined selection criterion;
said array of active antennas is commanded to create a receive beam with a predetermined reference shape to receive test signals transmitted by said plurality of selected calibration transponder-stations;
using a statistical approach, the angular distribution of the test signals received from said plurality of selected calibration transponder-stations is used to estimate the real shape of the receive beam created by said array of active antennas;
said reference and estimated shapes of said receive beam created by said array of active antennas are compared;
said base station determines the calibration to be effected on said receive systems according to the result of said comparison.

7. The method claimed in claim 1 wherein, in the case of calibration of said transmit systems, said method comprises the following steps for a given calibration transponder-station:
said base station transmits to said calibration transponder-station a first request for measurement during a predetermined first period and a second request for measurement during a predetermined second period;
said base station transmits a predetermined first test signal during said predetermined first period and said array of active antennas is commanded to assure substantially homogenous transmission in an area in which said calibration transponder-station is assumed to be located;
said calibration transponder-station effects at least a first measurement of said first test signal received and sends said base station a first response containing said at least one first measurement;
said base station receives and then processes said first response to deduce from it the angle of arrival associated with said calibration transponder-station;
said base station transmits a predetermined second test signal during said predetermined second period and said array of active antennas is commanded to create a transmit beam that can depend on said angle of arrival deduced by processing the first response received;
said calibration transponder-station effects at least one second measurement of said second test signal received during said predetermined second period and sends said base station a second response containing said at least one second measurement;
said base station receives and then processes said second response;
said base station compares said at least one first and second measurements and determines the calibration to be effected on said transmit systems according to the result of said comparison.

8. The method claimed in claim 7 wherein, in said step of transmission by said base station of said second test signal, the intention is for the transmit beam created by said array of active antennas to have a power maximum substantially in accordance with said angle of arrival deduced from the processing of the first response received, i.e. the assumed direction of said calibration transponder-station.

9. The method claimed in claim 7 wherein, in said step of transmission by said base station of said second test signal, the intention is for the transmit beam created by said array of active antennas to have a propagation zero substantially in accordance with the angle of arrival deduced from the processing of the first response received, i.e. in the assumed direction of said calibration transponder-station.

10. The method claimed in claim 1 wherein, in the case of calibration of said transmit systems, said method comprises the following steps:
said base station broadcasts a request for measurement to be effected during a predetermined period, said measurement request also selecting a plurality of calibration transponder-stations in accordance with at least one predetermined selection criterion;
said base station transmits a predetermined test signal during said predetermined period, said array of active antennas being commanded to create a transmit beam with a predetermined reference shape;
each of said selected calibration transponder-stations effects at least one measurement of the received test signal and sends said base station a response containing said at least one measurement;
using a statistical approach, the angular distribution of the responses received from said plurality of selected calibration transponder-stations is used to estimate the real shape of the transmission beam created by said array of active antennas;
said reference and estimated shapes of the transmit beam created by said array of active antennas are compared;
said base station determines the calibration to be effected on said transmit systems in accordance with the result of said comparison.

11. The method claimed in claim 6 or claim 10 wherein said at least one selection criterion belongs to the group comprising:
information related to the identification number of the mobile station; and
information related to the power level measured by the mobile station.

12. The method claimed in claim 6 or claim 10 wherein said plurality of selector calibration transponder-stations uses a collision management technique during said step of transmission of test signals or during said step of transmission of responses containing the measurements.

13. A mobile station of a space division multiple access digital cellular mobile radio system adapted to communicate with a base station associated with a cell in which said mobile station is located, said base station comprising an array of active antennas driven by receive and/or transmit systems for dynamically creating receive and/or transmit beams in the direction of said mobile station, wherein said mobile station comprises means for receiving and/or transmitting at least one test signal for calibrating said receive and/or transmit systems so that it can be used, in addition to its conventional function, as a calibration transponder.
